(19) United States
(12) Patent Application Publication
(10) Pub. No.: US 2015/0154960 A1
(43) Pub. Date: Jun. 4, 2015

(54) SYSTEM AND ASSOCIATED METHODOLOGY FOR SELECTING MEETING USERS BASED ON SPEECH

(71) Applicant: CISCO TECHNOLOGY, INC., San Jose, CA (US)

(72) Inventors: Smiling AI, Suzhou (CN); David YE, Suzhou (CN)

(73) Assignee: CISCO TECHNOLOGY, INC., San Jose, CA (US)

(21) Appl. No.: 14/094,271

(22) Filed: Dec. 2, 2013

(51) Int. Cl. G10L 17/00

(52) U.S. Cl. CPC G10L 17/005

(57) ABSTRACT

In one embodiment, video and audio data of a plurality of users is received from at least one external device and a speaking user is identified from at least one of the video and audio data. One or more phrases is extracted from the audio data and at least one database is accessed to identify a different user based on the one or more extracted phrases. This different user is designated as the speaking user and the video, audio data and at least a portion of the user data is transmitted to a client device such that a communication session of the client device is updated.

The present disclosure relates generally to a system and associated method for providing selection of one or more users from a group meeting based on speech identified in the meeting.

### BACKGROUND

With the widespread proliferation of Internet usage in recent years leading to global communications, the use of telecommunications has become increasingly important. Specifically, companies and individuals wishing to connect with each other can do so via video teleconferencing thereby allowing users to hold meetings as if they were talking in the same room. Due to the increasing number of people that join these meetings, it can become difficult to organize attendees in a manner easily understood by a host or other members of the meeting. Accordingly, if a meeting attendee asks a question, it may be burdensome for the host to determine one or more suitable attendees to answer the question.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary system according to one example.

FIG. 2 illustrates an exemplary system according to one example.

FIG. 3 illustrates an exemplary method for selecting a meeting user based on speech according to one example.

FIG. 4 illustrates user attendee data according to one example.

FIG. 5 illustrates an exemplary display of a communication session according to one example.

FIG. 6 illustrates an exemplary hardware configuration of the system server server according to one example

### DESCRIPTION OF EXAMPLE EMBODIMENTS

### Overview

In one embodiment, video and audio data of a plurality of users is received from at least one external device and a speaking user is identified from at least one of the video and audio data. One or more phrases is extracted from the audio data and at least one database is accessed to identify a different user based on the one or more extracted phrases. This different user is designated as the speaking user and the video, audio data and at least a portion of the user data is transmitted to a client device such that a communication session of the client device is updated.

### EXAMPLE EMBODIMENTS

Referring now to the drawings, wherein like reference numerals designate identical or corresponding parts throughout the several views.

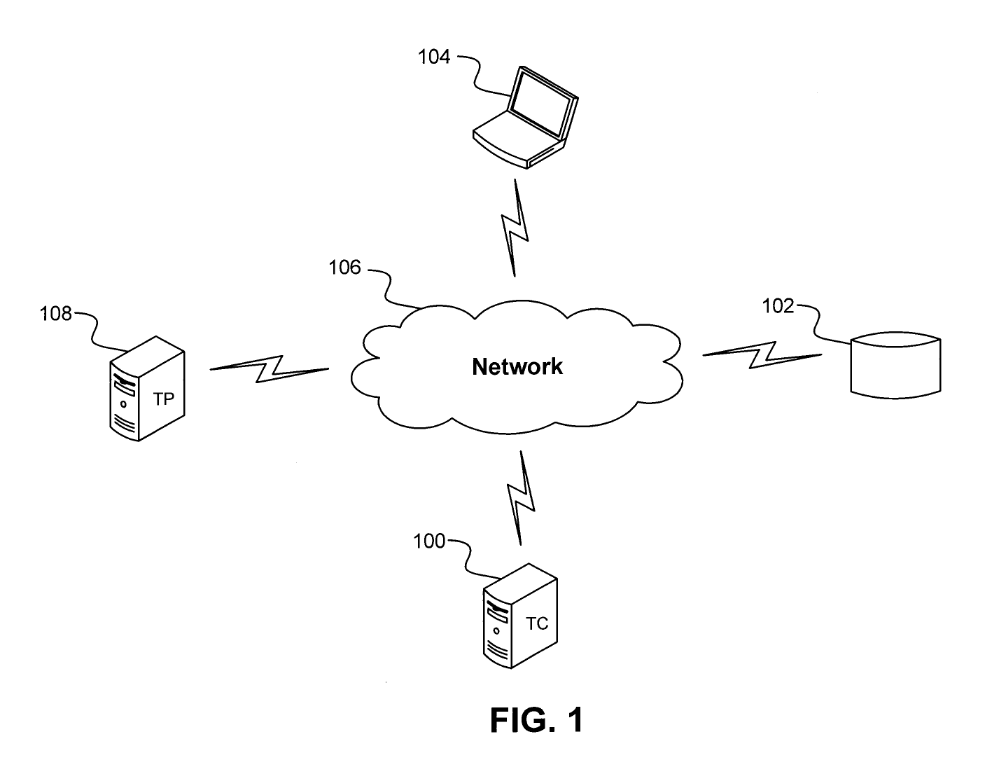

FIG. 1 illustrates an exemplary system according to one example. In FIG. 1, a teleconferencing server 100 is connected to a client device 104, a telecommunications server 108 and a database 102 via network 106. Client device 104 is connected to the teleconferencing server 100, telecommunications server 108 and the database 102 via the network 106. Similarly, the database 102 is connected to the client device 104, the telecommunications server 108 and the teleconferencing server 100 via the network 106. It is understood that the teleconferencing server 100, telecommunications server 108 and database 102 may represent one or more servers and databases, respectively. In other selected embodiments, the database 102 may be part of the teleconferencing server 100 and/or telecommunications server 108 or external thereto.

The client device 104 represents one or more computing devices, such as a smart phone, tablet, or personal computer, having at least processing, storing, communication and display capabilities as would be understood by one of ordinary skill in the art. The telecommunications server 108 represents a server for providing teleconferencing capabilities as would be understood by one of ordinary skill in the art. The database 102 represents any type of internal or external storage provided as part of the teleconferencing server 100 and/or telecommunications server 108 or provided in the cloud as part of a server farm as would be understood by one of ordinary skill in the art. The database 102 can store any type of information including information relating to users involved in an online communication session. The network 106 represents any type of network, such as Local Area Network (LAN), Wide Area Network (WAN), intranet and Internet.

In selected embodiments, a user of the client device 104 may wish to communicate with other users via a teleconferencing system, such as the teleconferencing server 100, having video and/or audio capabilities over the network 106. For example, Cisco System's, Inc.™ WebEx™ Web Conferencing system provides particular teleconferencing capabilities to remote users in a variety of locations and may represent the teleconferencing server 100 in an exemplary embodiment. Using the WebEx™ system, a user in the United States can have a video meeting online with a user in Norway and a user in Italy. Each user in the meeting may be identified and displayed as a separate attendee in the meeting so that a group of attendees can easily be determined and organized. Speaking users may also be identified by assigning a particular symbol next to a picture of identification information of a user who is speaking. Speaking users may also be displayed more prominently or at a particular location with respect to other meeting attendees. As more attendees join the meeting, they are newly added and attendee data is updated with the new user information so that other users will be aware of the new attendees. Therefore, a plurality of individual users can easily communicate with each other via the teleconferencing services provided by the WebEx™ system or other systems of a similar type.

Another type of teleconferencing, such as a telepresence session via telecommunications server 108, can also be used for online communications. Telepresence utilizes dedicated hardware to provide a high-quality video and audio conference between two or more participants. For example, Cisco System's, Inc.™ TelePresence System TX9000™ and 3000™ series provides an endpoint at the location at which a plurality of users in a single room can communicate with others at various locations. For instance, the TX9000™ systems is capable of delivering three simultaneous 1080p60 video streams and one high-definition, full-motion content-sharing stream. With these systems, an office or entire room are dedicated to providing teleconferencing capabilities for a large group of people.

In one scenario, a communication session may have been organized between a large number of individuals either within the same entity or within different entities. For example, a communication session could consist of tens, hundreds or thousands of individuals from different organizations and different countries throughout the world. In selected embodiments, these communications sessions will have a host who hosts the meeting and runs the meeting. The host may have special speaking privileges such that the host is the only one who may talk at a certain time while all other user attendees of the communication session are muted. The host may also select one or more particular individuals within the communication session to talk while all others are muted. Therefore, the host may mediate the meeting by providing speaking privileges at allotted times or to individuals who are best suited to speak at a particular time.

For example, a discussion of the communication session may be centered on a specific topic and a question may arise to which the current speaker and the host don't know the answer. In this situation, the host must find an appropriate user within the communication session to answer the question or speak in regards to the specific topic and provide that user with speaking privileges. This could be an incredibly daunting task to the host as he or she may not know the specific backgrounds of people within the communication session. Further, a variety of users of the communication session may be vying for the opportunity to speak on such a question and the host may not have enough information to determine which particular user should speak. Communication sessions having a large number of attendees only exacerbates this problem and allowing every user to speak may result in too much clutter. Therefore, as described further herein and in selected embodiments, a system server advantageously provides the ability to automatically identify particular individuals from the communication session to have speaking privileges based on speech generated during the communication session. In this context and in selected embodiments, the system server may be represented by either the teleconferencing server 100 and/or the telecommunications server 108. However, in other selected embodiments, the system server may be represented as an additional server that processes information received from the teleconferencing server 100 and/or the telecommunications server 108. However, for the purposes of explanation, it will be assumed that the teleconferencing server 100 represents the system server.

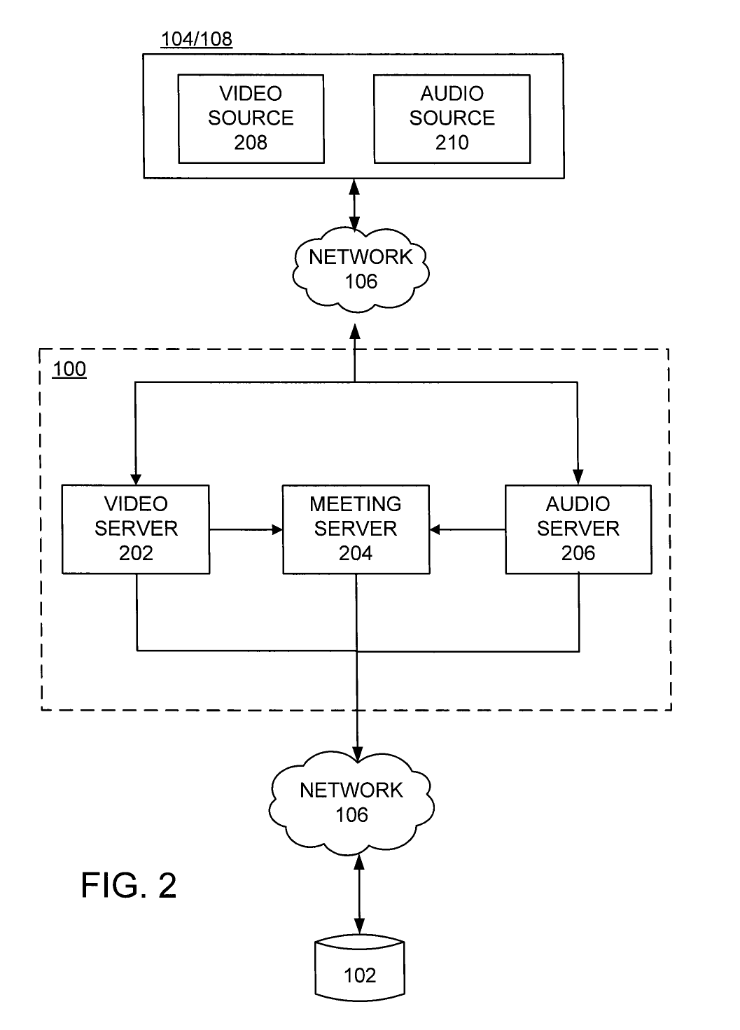

FIG. 2 illustrates an exemplary system according to one example. In FIG. 2, some items are similar to those previously described in other figures and therefore like designations are repeated. As illustrated in FIG. 2, an external server and/or client device, such as the telecommunications server 108 and client device 104, are connected via the network 106 to the system server 100 having a video server 202, meeting server 204 and audio server 206. However, in selected embodiments, the video server 202, meeting server 204 and audio server 206 may be a single server. The external server can represent one or more telecommunications servers 108 and/or one or more client devices 104. The telecommunications server 108 contains one or more video sources 208 providing video of an online communication such as a telepresence stream along with corresponding audio from a one or more audio sources 210. The video sources 208 may be provided, for example, by video cameras positioned throughout an office room and the audio sources 210 may be provided, for example, by microphones positioned throughout an office room. The client device 104 also contains one or more video sources 208 and audio sources 210. These video sources 208 may be provided, for example, by a video camera built into a PC and/or mobile device. Similarly, the audio sources 210 of the client device may be provided, for example, by microphones built into or external to a PC and/or mobile device.

FIG. 2 also illustrates that the system server 100 is connected to the database 102 via the network 106. As described further herein, any communications sessions running on the system server 100 may be updated based on communications received from external devices, such as the telecommunications server 108 and client devices 104, and information received from the database 102. The updated communications session can then be transmitted from the system server 100 to the client devices 104 and telecommunications server 108.

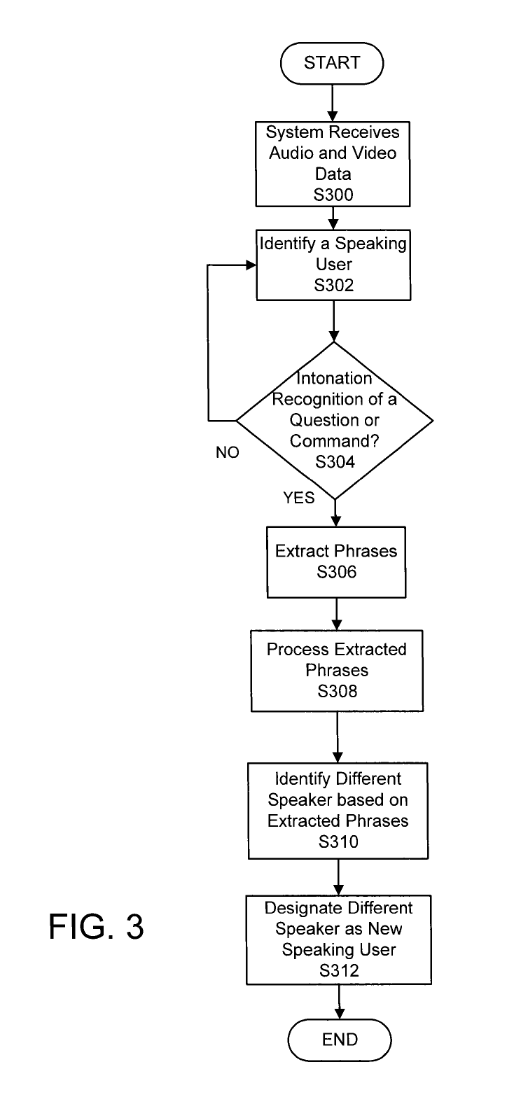

In this exemplary embodiment, the system server 100 may receive video streams from users of one or more telecommunications servers 108 and client devices 104 and host them in one communication session to provide automatic recommendations to the host (who may be located on any of the one or more telecommunication servers 108 and client devices taking part in the communication session) as to which user should be provided speaking privileges based on speech generated in the communication session. Thus, in selected embodiments, the audio server 206 may identify whether a speaking user asked a question or spoke a command at which point the audio server 210 can automatically identify particular keywords from the question or command and query the database 102 for answers. Similarly, For example, and as described further herein, a current speaker may ask who is an expert in a certain technology area at which point the audio server 206 may query the database 102 for an expert and once identified send this information to the meeting server 204 along with a designation of which meeting the user selection refers to as the meeting server 204 may be hosting multiple meetings. The meeting server 204 can then provide speaking privileges to the selected user or users and submit this permission to the particular client device 104 or telecommunication server 108. The corresponding audio stream from the audio source 208 of the client device 104 and/or telecommunications server 108 is then passed to the audio server 206 along with the corresponding meeting number so that users in the communication session can now hear the selected users speak. The specific methodology of how the teleconferencing system 100 provides these features and their corresponding advantages is described further herein with respect to FIG. 3.

FIG. 3 illustrates a method for selecting a meeting user based on speech. As illustrated in FIG. 2 and at step S300, the system server 100 receives audio and video data from one or more external devices. For example, in selected embodiments the system server 100 may receive audio and video data from the one or more client devices 104 and telecommunications servers 108. As previously described herein, the client devices 104 may represent a variety of different communications hardware for performing teleconference-based communication. As such, the system server 100 may receive via network 106 video and audio data simultaneously from one or more mobiles devices, such as cell phones and laptops, one or more personal computers, and one or more telecommunications systems. This audio and video data is then used to form the communication session representing a meeting between a plurality of users on corresponding equipment and hosted by the system server 100.

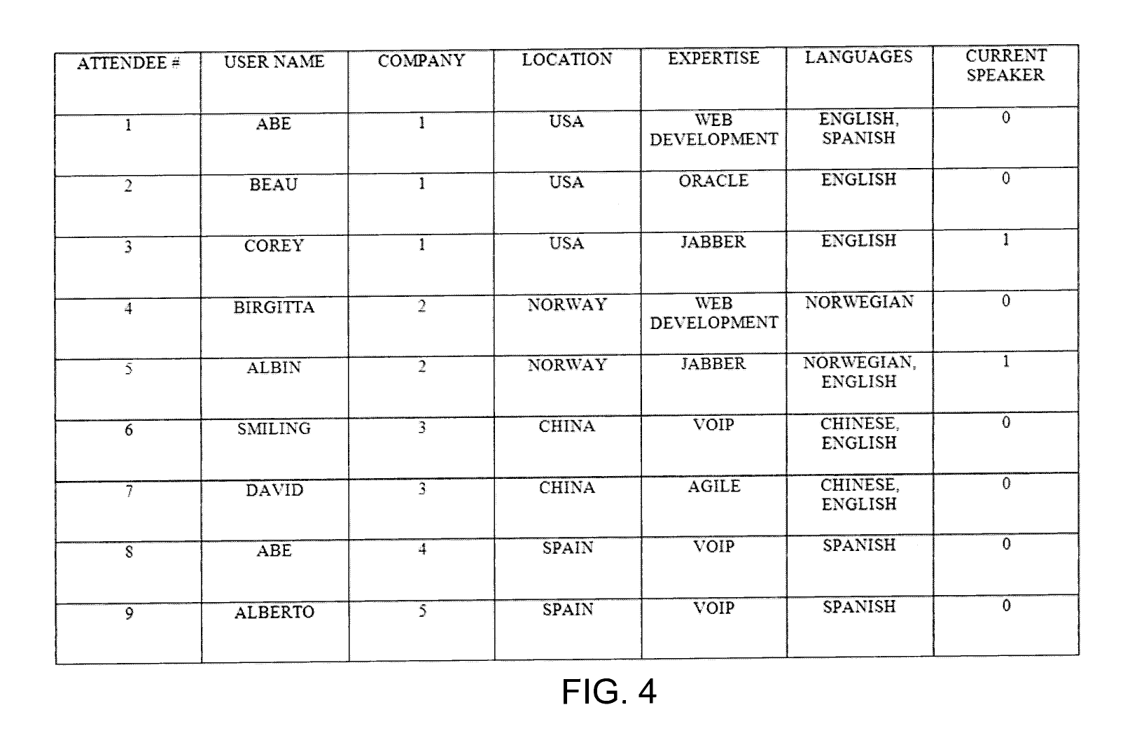

The communication session hosted by the system server 100 also provides, via network 106, information with respect to the communication session back to the client devices 104 and/or telecommunications server 108. Thus, the system server 100, in generating the communication session, identifies each user based on each individual stream and forms a virtual teleconferencing meeting room. For streams having more than one user, such as those generated from a telecommunications server 108 as previously described herein, each user can be identified within the stream as described in application U.S. Ser. No. 14/011,489, the entirety of which is herein incorporated by reference. Identification information of participants of the communication session, such as names, images, location, joining time and leaving time may be included as part of the information of the communication session. This information, such as names, images and location may be received from the client devices 104 and/or telecommunications server 108 or may accessed by the system server 100 via database 102 as described further herein with respect to FIG. 4. Further, the system server 100 can generate information identifying the time at which users join and leave a particular communication session.

At this point, and for purposes of explanation, it is assumed that a communication session between client devices 104 and the telecommunications server 108 has been generated by the system server 100 as would be understood by one of ordinary skill in the art. Accordingly, the system server 100 has identified a plurality of meeting users based on video and audio data received from the client devices 104 and the telecommunications server 108. The system server 100 has then organized all of these users into a single virtual online meeting room. The system server 100 also identifies each user based on the information received from the database 102 and sets up records for each user by associating together information such as the user name and the user image. This information is then transmitted by the system server 100 via the network 106 to the client devices 104 and telecommunications server 108 for native display to the respective participants of the communication session. This information is updated at predetermined intervals and based on information generated by the system server 100 as to who has joined and left the communication session and the respective times of joining and leaving the communication session.

At step S302, the system server 100 identifies one or more meeting attendees who are currently speaking in the communication session. The system server 100 may determine the current speaker(s) based on whichever user has been afforded speaking privileges by the host as all other speakers within the communication session will be muted. The system server 100 may also determine the current speaker based on the audio data received from the audio sources 210 of the client devices 104 and telecommunications server 108. In other words, based on signal recognition, voice recognition and/or ambient noise filters as understood by one of ordinary skill in the art, the system server 100 can identify from the audio data which user is speaking into the microphone. For video and audio streams containing multiple users, such as those generated by the telecommunications server 108, the speaking user may be identified based on voice recognition or speaker location information identifying a user assigned to a particular microphone in the room. This information, whether identified based on privileges or signal processing, may then be stored and continuously updated in the database 102. The system server 100 may also identify the speaking user based on video processing of streams received from the one or more external devices. Specifically, video processing to identify motion vectors with respect to successive frames surrounding the mouth of a user as detected via facial recognition techniques as would be understood by one of ordinary skill in the art may also be used to detect speaking users.

Once the system server 100 has identified one or more speaking users, the system server 100 in step S304 recognizes phonetic patterns, such as intonation recognition, to identify, for example, when users are asking a question or giving a command as described in EP 1286329, the entire contents of which are incorporated herein by reference. Intonation arises out of the level of stress when speaking various words and phrases. Stress can be classified as either lexical stress or phrasal stress, where lexical stress of a word does not change according to the context of a corresponding utterance and the phrasal stress of an utterance changes depending on the context of the utterance. Accordingly, in selected embodiments, the system server 100 can produce a string of text from a spoken sequence based on stress and utilize the intonation pattern of the language, such as the modulation, rise and fall of the pitch of the voice, for selection of one or more particular words and/or phrases as described in EP0683483, the entire contents of which are herein incorporated by reference. Accordingly, in selected embodiments, the system server 100 can implement algorithms to accurately detect whether an utterance is a question, command or statement as described in “Recognizing Intonational Patterns in English Speech,” Panttaja, Erin Marie, Massachusetts Institute of Technology (1998).

Therefore, in step S304 and in selected embodiments, the system server 100 identifies whether a speaking user is asking a question. If the system server determines that the user is not asking a question then the processing is returned to step S302 to identify a speaking user thereby identifying whether the same user is talking or a different user has been assigned the speaking privilege. If the system server 100 determines through speech processing that a user has asked a question, then processing proceeds to step S306 to extract phrases based on speech from the user who asked a question. In selected embodiments, the system server 100 may also identify at step S304 whether a command has been issued by the speaking user based on inflection patterns and intonation of the speech. Accordingly, if a command has been issued by the user, the processing proceeds to step S306 whereas if a command or question have not been detected the processing proceeds back to step S302. Further, in selected embodiments the system server 100 may select users only based on whether a question has been asked or based on whether a command has been issued.

At step S306, the system server 100 analyzes the speech provided from the audio data received from the corresponding client devices 104 and/or telecommunications server 108 to convert the speech into text as described in and as described by U.S. Pat. No. 7,225,130 and U.S. Pat. No. 6,151,572, the entire contents of which are herein incorporated by reference. Accordingly, in selected embodiments, the speech is analyzed by identifying waveform signals generated from a microphone based on the variation of air pressure over time. The waveform signals can be converted by a digital signal processor into a time domain representation having a plurality of parameter frames representing waveform proprieties over a period of time. These are matched against sequences of phonetic models corresponding to different words of a vocabulary. A probability threshold may then be established for identifying whether a certain word was actually spoken or not. Further, to update the effectiveness of the speech recognition, the phonetic models corresponding to different words in a dictionary can be updated as described in U.S. Pat. No. 6,389,394, the entire contents of which are herein incorporated by reference.

Once the system server 100 has extracted words, phrases, sentences or the like from the speech uttered by a user, the system server 100 proceeds to process the extracted phrases at step S308. The goal of processing the phrases extracted from the speech uttered by the user with the speaking privilege is to identify what the user was seeking when asking a question or presenting a command. For example, the system server 100, utilizing the speech recognition and processing features previously described herein, may identify that the user asked the question “Who knows a lot about web development?” or stated the command “find me someone who can speak Spanish.” Based on the tonal intonation, rise in pitch and/or lexicological stress, the system server 100 at step S304 can determine that a question or command was presented by a user and then proceeded to extract phrases from the question or command in step S306. However, at this point, the system server 100 must identify what to do with the phrases extracted from the speech in order to obtain an answer to the question or provide a response to a command. In other words, the system server 100 must find a user in the communication session who has knowledge of web development or a user in the communication session who speaks Spanish.

To perform such processing when determining that a question or command has been asked by a user of the communication session, the system server 100 identifies key words in the extracted phrases on which to perform searching operations. For example, the system server 100 can identify the words “web development” as an important phrase from the question “who knows a lot about web development?” This can be accomplished by ignoring articles such as “a” and “the”, prepositions and verbs. Further, the system server 100 can utilize co-reference processing to identify links between various sentences or phrases closely linked in time with respect to when they were uttered by the user. For example, one user, Albin, might state “I don't know much about web development” and another user, Corey, having a speaking privilege as well might answer “I am not an expert. Who can introduce it?” Here, the system server 100 will recognize from intonation recognition that a question was asked and proceed to extract the above phrases from the overall links of speech uttered by the users. Once those specific phrases are uttered, co-reference resolution processing may be performed for resolution of noun phrases within the extracted speech as described in ‘A Machine Learning Approach to Coreference Resolution of Noun Phrases,” Soon, Wee Meng; Lim, Daniel Chung Yong; NG, Hwee Tou, Association for Computational Linguistics (2001).

Specifically the system server 100 can determine whether two expressions in natural language refer to the same entity in the world. This provides the ability to link coreferring noun phrases both within and across sentences to provide a better comprehension of what the speaking user is requesting. For example, Albin indicated that he did not know much about web development whereas Corey answered by asking who could introduce “it”. Here, the term “it” was not uttered in the same sentence, much less by the same person but it does in fact refer to web development. Therefore, when Corey asks who can introduce “it”, the system server 100 recognizes that a question is being asked in Step S304, extracts the phrases uttered by Albin and Corey in step S308 and then performs coreference resolution processing to properly link terms between phrases to identify that the users are seeking someone with knowledge of web development.

Once the system server 100 has identified what the user is seeking based on the above-noted processing, the system server 100 identifies a new speaking user based on the information included in the extracted phrases. Specifically, at this point, the system server 100 has extracted words specific to “web development” and knows that these items are important to the speaking user and that another user must be identified who has knowledge of such technology. Accordingly, in step S310, the system server 100 generates a plurality of searchable keyword terms based on the extracted phrases. In this simplified version, the system server 100 generates keywords “web development” and performs a search of the database 102 to identify appropriate users who can speak based on these topics.

FIG. 4 illustrates user attendee data stored in the database 102 according to one example. As illustrated in FIG. 4, the system server 100 has designated nine attendees as being part of the communications session. For each attendee, the database 102 provides information as to the user name, company or organization, location, expertise, language and a designation of who the current speaker is in the communication session. This exemplary list is not exhaustive, however, and other identifying information could be included such as address, image information, age, company name, user join time, user leave time and the like. Further, as illustrated in FIG. 4 and in correlation to the example described previously herein, both Albin and Corey currently have speaking privileges in the communication session. Also, users from the same group or company (i.e. users 1-3) may indicate that they are sending video and audio information to the system server 100 from a telepresence system such as TX9000™ whereas single users from a single company or home may indicate that they are using a teleconferencing system such as WebEx™. The database 102 is continuously updated based on information provided from the client devices 104 and telecommunications server 108 or by updates provided by the system server 100. Further, the system server 100 updates the list as new users join the meeting and other users leave the meeting.

Referring back to FIG. 3, step S310, the system server 100 uses the keyword “web development” to search the database 102 for an appropriate user or users who have a working knowledge of web development. Accordingly, by performing this search, the system server 100 identifies Abe and Birgitta as experts in web development. At this point, the system server 100 could assign at Step S312 both Abe and Birgitta speaking privileges while removing Corey and Albin from having speaking privileges. It could also make all four users active speakers to allow for a group conversation. Alternatively, this can be manually set by the host of the communication session.

The system server 100 may also perform various processing to identify one or more speakers who are best qualified to speak at a particular time based on the keyword determined by the system server 100 from the question or command. For example, the system server 100 may determine the language ability of the majority of users and provide speaking privileges based on this determination. For example, if a majority of people in the communication session speak English, the system server 100 may only afford at step S312 Abe speaking privileges as Abe speaks English and Birgitta only speaks Norwegian. Further, the database 102 may identify the amount of years in which each user has expertise for a particular technology and determine which speaker should get speaking privileges based on who has the most experience. Title information, such as hierarchical ranking structure, may also be stored in the database 102 and used by the system server 100 to identify one or more qualified speaking users in priority order. Further, the database 102 may establish predetermined priority settings for distinguished users within the communication session. For example, a recognized pioneer in a certain technology area or a user having a large number of publications in a particular technology area may obtain priority status for speaking privileges when questions or commands arise relating to their technological expertise.

Further, names provided in a question or command extracted by the system server 100 provide important information when performing a search. For example, if the host asks the question “Abe, can you provide us with some information on voice over IP?”, the system server 100 formulates a keyword involving voice over IP and Abe thereby searching across multiple categories of data stored in the database 102 to identify Abe from Spain as the expert who should receive speaking privileges while not providing speaking privileges to Abe from the United States. Once the system server 100 has designated one or more speakers as having the speaking privilege at step S312, the database 102 is updated and the information displayed to users of the communication session may also be updated by transmitting updated information from the system server 100 to the client devices 104 and the telecommunications server 108.

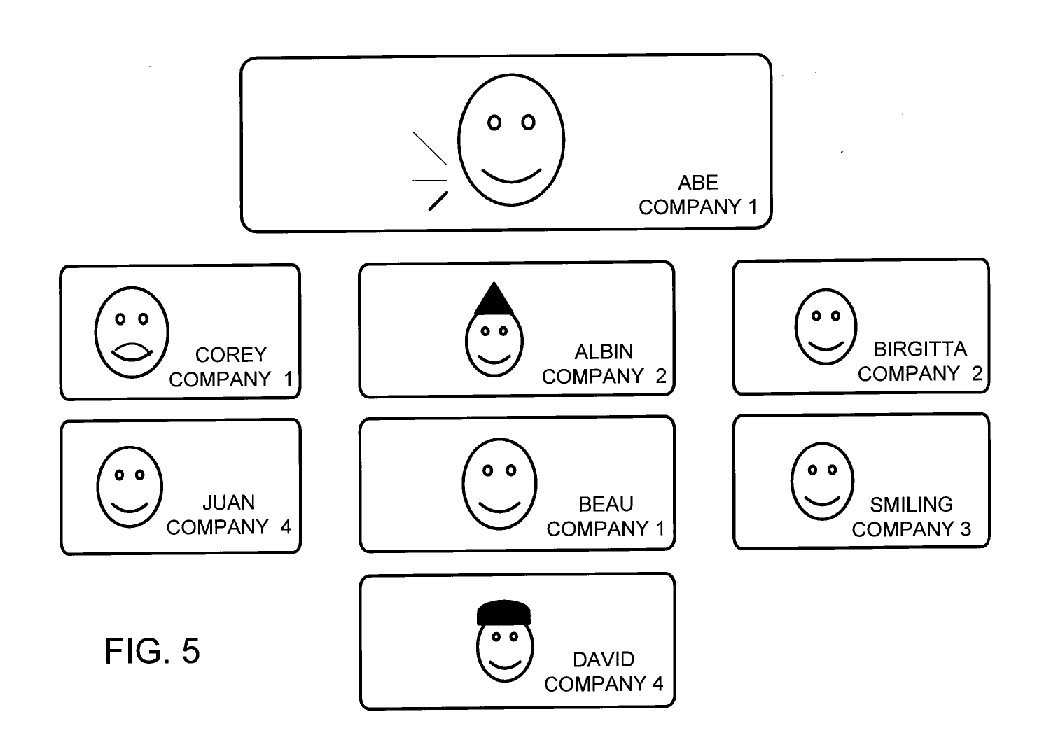

FIG. 5 illustrates an exemplary display of an updated communication session according to one example. As illustrated in FIG. 5, each user may be separately identified and may also be provided with a user name and location based on the data from database 102. Further, the current user who has the speaking privileges may be prominently displayed in the communication session window to clearly identify who is speaking. The host may also be prominently displayed in selected embodiments. Once the communication session is updated as the system server 100 identifies new speakers with speaking privileges, the display of the various users may be altered based on speaking privileges and who previously had speaking privileges. For examples, as illustrated in FIG. 5, Abe has been designated with speaking privileges as the system server 100 identified him as a speaking user based on his English and web development skills and therefore Abe is displayed most prominently. However, as Corey and Albin were the previous speakers they are also prominently displayed as they are actively involved in the current communications. Further, Birgitta may also be prominently displayed even though she was selected for speaking privileges due to her expertise with respect to the technology (web development) currently being discussed. Accordingly, as the communication session is updated with additional users based on additional streams of data, the communication session illustrated in FIG. 5 may be changed to accommodate different users who are speaking, new users to the communication session, and users leaving the communication session. The communication session may be further updated based on factors such as who hosted the meeting, who is running the meeting, occupation title priority, a predetermined priority, idle time vs. speaking time, or the current technology being discussed as identified by the system servers 100 speech recognition processing.

Further, in selected embodiments, the system server 100 can provide the host with the ability to perform a roll call in a communication session with a large number of participants. For example, the host can perform a roll call to confirm that every site or organization involved in the communication session has a representative by speaking corresponding site names. The system server 100 speech recognition can recognize the site name and then provide the host with the members of the site who are participating in the meeting and an indication of whether they are present. This can be performed for every site involved in the communication session until the host gets a full attendance list of who is actively participating in the communication session.

The system server 100, in selected embodiments, provides a variety of advantageous features in addition to those previously described herein. Traditionally, users in a communication session would have to raise their hand or take specific actions to get a speaking or privilege from the host or the host would have to specifically pick out one or more particular users to assign speaking privileges. However, this is not required as the system server 100 can automatically assign users speaking privileges based on conversation in the communication session so that the host is not burdened with such as task. Further, as there could be hundreds or thousands of people in the communication session or even a small number of people who do not know each other, the host does not have to worry about keeping up to date records on who is an expert in a particular area or where particular users are from as the system server 100 monitors all of this information via database 102 and provides speaking privileges based on this information. Further, as all of the users cannot always be displayed on a screen, the system server 100 can intelligently update the information provided to the user so that particular streams (i.e. users) are displayed based on who is the current speaker, who is hosting the communication session or based on characteristics of particular users in the database 102 with respect to the what the current conversation relates to. This allows the host to easily recognize the presence of relevant people even if somebody joins or leaves the communication session. Further, users participating in the communication session can identify personal information of related users ahead of time thereby obtaining their information for additional discussion or conversations whereas they might not have otherwise recognized particular users among hundreds of other users in a crowded communication session. Additionally, the automated selection of users by the system server 100 can greatly reduce inefficiencies and errors in user selection by the host thereby increasing the quality of the conversation while reducing the time required to hold particular communication sessions.

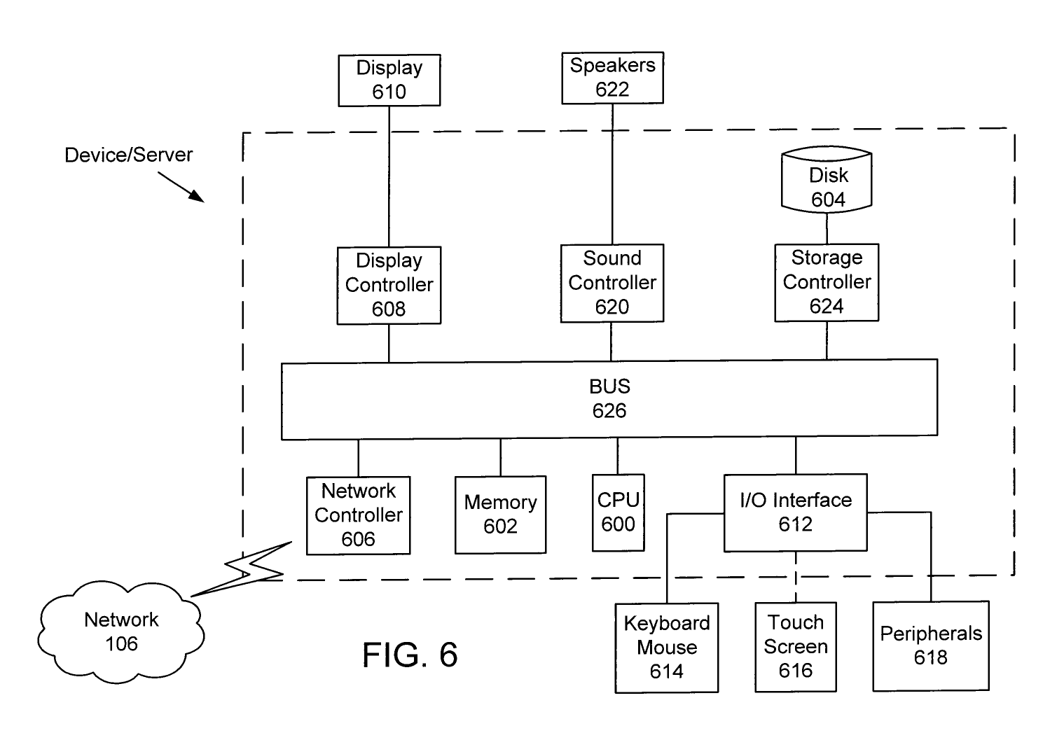

Next, a hardware description describing the system server 100 according to exemplary embodiments is described with reference to FIG. 6. In FIG. 6, the system server 100 includes a CPU 600 which performs the processes described above. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server communicates, such as another server or computer.

Further, the above-noted processes may be provided as a utility application, background daemon, or component of an operating system, or combination thereof, executing in conjunction with CPU 600 and an operating system such as Microsoft Windows 8, UNIX, Solaris, LINUX, Apple MAC-OS and other systems known to those skilled in the art.

CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The system server 100 in FIG. 6 also includes a network controller 606, such as an Intel Ethernet PRO network interface card from Intel Corporation of America, for interfacing with network 106. As can be appreciated, the network 106 can be a public network, such as the Internet, or a private network such as an LAN or WAN network, or any combination thereof and can also include PSTN or ISDN sub-networks. The network 106 can also be wired, such as an Ethernet network, or can be wireless such as a cellular network including EDGE, 3G and 4G wireless cellular systems. The wireless network can also be WiFi, Bluetooth, or any other wireless form of communication that is known.

The system server 100 further includes a display controller 606, such as a NVIDIA GeForce GTX or Quadro graphics adaptor from NVIDIA Corporation of America for interfacing with display 610, such as a Hewlett Packard HPL2446w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the system server 100, such as Sound Blaster X-Fi Titanium from Creative, to interface with speakers/microphone 622 thereby providing sounds and/or music. The speakers/microphone 622 can also be used to accept dictated words as commands for controlling the system server 100.

The general purpose storage controller 624 connects the storage medium disk 604 with communication bus 626, which may be an ISA, EISA, VESA, PCI, or similar, for interconnecting all of the components of the system server 100. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

Any processes, descriptions or blocks in flow charts should be understood as representing modules, segments, portions of code which include one or more executable instructions for implementing specific logical functions or steps in the process, and alternate implementations are included within the scope of the exemplary embodiment of the present system in which functions may be executed out of order from that shown or discussed, including substantially concurrently or in reverse order, depending upon the functionality involved, as would be understood by those skilled in the art. Further, it is understood that any of these processes may be implemented as computer-readable instructions stored on computer-readable media for execution by a processor.

Obviously, numerous modifications and variations of the present system are possible in light of the above teachings. It is therefore to be understood that within the scope of the appended claims, the system may be practiced otherwise than as specifically described herein.

1. A method implemented by at least one server, the method comprising:
at the at least one server
receiving video and audio data of a plurality of users from at least one external device; and
via a processor,
identifying a speaking user from at least one of the video and audio data;
extracting one or more users phrases from the audio data;
accessing at least one database to identify a different user based on the one or more user extracted phrases;
designating the different user as the speaking user; and
transmitting the video data, audio data and at least a portion of the user data to a client device,
wherein a communication session of the client device is updated based on the video data, audio data and user data.

2. The method according to claim 1, further comprising:
performing intonation recognition on selected portions of the audio data, and
extracting the one or more user phrases based on intonation recognition.

3. The method according to claim 2, wherein the extracting extracts the one or more user phrases in response to determining, based on the intonation recognition and for the selected portion of the audio data, that a question is being asked by a user.

4. The method according to claim 2, the extracting extracts the one or more user phrases only in response to determining, based on the intonation recognition and for the selected portion of the audio data, that a question is being asked by a user.

5. The method according to claim 1, wherein the user data includes information identifying users who are attendees of the communication session.

6. The method according to claim 1, wherein the user data includes in part identification information of each user including at least one of user group information, user name information, user location information and user expertise information.

7. The method according to claim 1, wherein each user of the communication session is separately displayed, on the client device, within the communication session along with corresponding user identification information.

8. The method according to claim 7, wherein the different user is displayed more prominently with respect to other users of the communication session.

9. The method according to claim 1, wherein
the user data includes in part expertise information of each user, and
the different user is identified by searching the at least one database to determine which expertise information matches with the one or more extracted phrases.

10. The method according to claim 1, wherein
the user data includes in part identification information of each user including at least one of organization information, user name information, user location information and user expertise information, and
the different user is identified by searching the at least one database to determine which identification information best matches with the one or more extracted phrases.

11. The method according to claim 1, further comprising:
assigning speaking privileges to the different user while simultaneously muting all other users of the communication session.

12. The method according to claim 1, wherein the processor searches an offline company directory based on the one or more extracted phrases.

13. A server, comprising:
an interface to receive video and audio data of a plurality of users from at least one external device, and
a processor programmed to
identify a speaking user from at least one of the video and audio data,
extract one or more users phrases from the audio data,
access at least one database to identify a different user based on the one or more user extracted phrases,
designate the different user as the speaking user, and
transmit the video data, audio data and at least a portion of the user data to a client device via the interface,
wherein a communication session of the client device is updated based on the video data, audio data and user data.

14. The server according to claim 13, wherein the processor is programmed
to perform intonation recognition on selected portions of the audio data, and
to extract the one or more user phrases based on intonation recognition.

15. The server according to claim 14, wherein the processor is programmed to extract the one or more user phrases in response to determining, based on the intonation recognition and for the selected portion of the audio data, that a question is being asked by a user.

16. The server according to claim 13, wherein
the user data includes in part expertise information of each user, and
the processor identifies the different user by searching the at least one database to determine which expertise information matches with the one or more extracted phrases.

17. The server according to claim 1, wherein
the user data includes in part identification information of each user including at least one of organization information, user name information, user location information and user expertise information, and
the processor identifies the different user by searching the at least one database to determine which identification information best matches with the one or more extracted phrases.

18. A non-transitory computer-readable medium having computer-executable instructions thereon that when executed by a computer causes the computer to execute a method comprising:
receiving video and audio data of a plurality of users from at least one external device;
identifying a speaking user from at least one of the video and audio data;
extracting one or more users phrases from the audio data;
accessing at least one database to identify a different user based on the one or more user extracted phrases;
designating the different user as the speaking user; and
transmitting the video data, audio data and at least a portion of the user data to a client device,
wherein a communication session of the client device is updated based on the video data, audio data and user data.

19. The non-transitory computer-readable medium according to claim 18, further comprising:
performing intonation recognition on selected portions of the audio data, and
extracting the one or more user phrases based on intonation recognition.

20. The non-transitory computer-readable medium according to claim 19, wherein the extracting extracts the one or more user phrases in response to determining, based on the intonation recognition and for the selected portion of the audio data, that a question is being asked by a user
